(19) United States
(12) Patent Application Publication
(10) Pub. No.: US 2014/0340675 A1
(43) Pub. Date: Nov. 20, 2014

(54) DISCRIMINATION METHOD AND APPARATUS OF CARDIAC TISSUE USING RAMAN SCATTERING

(71) Applicants: KYOTO PREFECTURAL PUBLIC UNIVERSITY CORPORATION, Kyoto (JP); The Graduate School for the Creation of New Photonics Industries, Shizuoka (JP); HORIBA, Ltd., Kyoto (JP)

(72) Inventors: Tetsuro Takamatsu, Kyoto (JP); Yoshinori Harada, Kyoto (JP); Takeo Minamikawa, Kyoto (JP); Nanae Muranishi, Kyoto (JP); Katsuhiro Ishii, Shizuoka (JP); Juichiro Ukon, Kyoto-shi (JP); Junichi Aoyama, Kyoto-shi (JP)

(73) Assignees: KYOTO PREFECTURAL PUBLIC UNIVERSITY CORPORATION, Kyoto (JP); The Graduate School for the Creation of New Photonics Industries, Shizuoka (JP); HORIBA, Ltd., Kyoto (JP)

(21) Appl. No.: 14/278,290

(22) Filed: May 15, 2014

(30) Foreign Application Priority Data
May 15, 2013 (JP) 2013-103435

(51) Int. Cl. G01N 21/65

(52) U.S. Cl. CPC G01N 21/65
USPC 356/301

(57) ABSTRACT

A method and an apparatus for discriminating a cardiac tissue using Raman scattering are provided which enable a noninvasive discrimination of the cardiac tissue to be accurately performed. The discrimination method includes: a step of irradiating a sample containing a cardiac tissue with excitation light; a step of detecting Raman scattering light from the sample; an analysis step of analyzing the detected Raman scattering light by a multivariate analysis using as an index, Raman scattering spectra which are specific to at least a living myocardial tissue, a necrotic myocardial tissue, a granulation tissue and a fibrotic tissue, respectively; and a step of discriminating the cardiac tissue in accordance with analysis results obtained in the analysis step.

### CROSS-REFERENCE TO RELATED APPLICATIONS

This Nonprovisional application claims priority under 35 U.S.C.§119(a) on Patent Application No. 2013-103435 filed in Japan on May, 15, 2013, the entire contents of which are hereby incorporated by reference.

### FIELD

The present invention relates to a method and an apparatus for discriminating a cardiac tissue by using a Raman scattering spectrum from the cardiac tissue.

### BACKGROUND

When myocardial infarction occurs in heart, it is important to have knowledge regarding a state of distribution of a living myocardial tissue and a damaged and changed tissue each composing the heart, as well as the proportion of each tissue and the like. There exists myocardial tissue biopsy as a procedure for getting such knowledge on a cardiac tissue. However, myocardial tissue biopsy necessitates fixation and staining of a specimen, leading to problems of failure to obtain the tissue distribution in real time, and to injury of the heart itself.

Also, as a noninvasive procedure, the information regarding a cardiac tissue is acquired by a magnetic resonance imaging (MRI) process. However, the resultant information is not based on an alteration of the myocardial cells, and thus it is impossible to definitely discriminate the living myocardial tissue and the changed tissue.

In the meantime, there exists Raman spectrometry in which: Raman scattering light generated when a sample is irradiated with excitation light, through an interaction with the sample, is detected from the sample; the spectrum of detected Raman scattering light is obtained; and components, chemical structures and the like included in the sample are identified by the spectrum of Raman scattering light. The Raman spectrometry is one of vibration spectrometry, and enables the analyses at molecular levels.

Using such Raman spectrometry, analyses of living tissues have been attempted in the medical field (Japanese Patent No. 4588324, U.S. Pat. No. 6,965,793, etc.). Japanese Patent No. 4588324 discloses a technique of diagnosing atherosclerosis in coronary artery based on Raman scattering spectra that are specific to smooth muscle cells, collagen fibers, elastic lamina, fat cells and foam cells, respectively, in blood vessel. In addition, U.S. Pat. No. 6,965,793 discloses discriminating a diseased tissue by Raman spectrometry, and presenting the boundary between a diseased tissue and a normal tissue by imaging.

### SUMMARY

Both Japanese Patent No. 4588324 and U.S. Pat. No. 6,965,793 are not directed to cardiac tissues, and any report on a procedure for an analysis of a cardiac tissue using Raman spectrometry has not been found.

The present inventors proposed a procedure of imaging an area consisting of a myocardial tissue containing normal myocardial cells, and an area consisting of a fibrotic tissue containing a great deal of collagen so as to be clearly distinguished through an analysis of Raman scattering light obtained from a sample that includes a cardiac tissue having myocardial infarction (PCT International Publication No. 2010/103661).

In the meanwhile, when myocardial infarction occurs, normal myocardial cells become necrotic first thereby resulting in an alteration of a living myocardial tissue to a necrotic myocardial tissue, and thereafter inflammatory cells, vascular endothelial cells and the like are migrated and proliferated to allow the necrotic myocardial tissue to be changed into a granulation tissue, finally leading to fibrosis of the tissue to yield a fibrotic tissue from the granulation tissue.

When considerable days have passed after an occurrence of myocardial infarction, i.e., in the case of old myocardial infarction, since almost all tissues of necrotizing myocardial cells are changed into fibrotic tissues, an accurate discrimination of the tissue is enabled using the aforementioned procedure proposed by the present inventors in which a tissue of myocardial cells and a fibrotic tissue are discriminated. However, in the case of an acute phase, i.e., when only a short time period has passed after an occurrence of myocardial infarction, or in a part of cases of old myocardial infarction, not only the fibrotic tissue but also the necrotic myocardial tissue and the granulation tissue are found. In such cases, if the tissue of myocardial cells and the fibrotic tissue are only the subjects to be analyzed, accuracy for a discrimination of the tissue may be inferior, and thus a further improvement has been still desired.

The present invention has been made in view of the foregoing circumstances, and an object of the present invention is to provide a method and an apparatus for discriminating a cardiac tissue using Raman scattering, which enable a noninvasive discrimination of cardiac tissue to be accurately performed through an improvement and progress of the above-described procedure for the discrimination of a cardiac tissue by way of Raman spectrometry as the present inventors proposed.

The discrimination method of a cardiac tissue using Raman scattering according to an aspect of the present invention includes: a step of irradiating a sample containing a cardiac tissue with excitation light; a step of detecting Raman scattering light from the sample; an analysis step of analyzing the detected Raman scattering light by a multivariate analysis using as an index, Raman scattering spectra which are specific to at least a living myocardial tissue, a necrotic myocardial tissue, a granulation tissue and a fibrotic tissue, respectively; and a step of discriminating the cardiac tissue in accordance with analysis results obtained in the analysis step.

In the discrimination method of a cardiac tissue using Raman scattering according to the aspect of the present invention, a partial least squares method may be employed for the multivariate analysis in the analysis step.

In the discrimination method of a cardiac tissue using Raman scattering according to the aspect of the present invention, the Raman scattering spectrum specific to the living myocardial tissue may be a Raman scattering spectrum derived from cytochrome.

In the discrimination method of a cardiac tissue using Raman scattering according to the aspect of the present invention, the Raman scattering spectrum specific to the fibrotic tissue may be a Raman scattering spectrum derived from collagen.

In the discrimination method of a cardiac tissue using Raman scattering according to the aspect of the present invention, the sample may contain an ischemic cardiac tissue.

The apparatus for discriminating a cardiac tissue using Raman scattering according to another aspect of the present invention includes: a means for irradiating a sample containing a cardiac tissue with excitation light; a means for detecting Raman scattering light from the sample; an analysis means for analyzing the detected Raman scattering light by a multivariate analysis using as an index, Raman scattering spectra which are specific to at least a living myocardial tissue, a necrotic myocardial tissue, a granulation tissue and a fibrotic tissue, respectively; and a means for discriminating the cardiac tissue in accordance with analysis results obtained by the analysis means.

In the present invention, a sample containing a cardiac tissue is irradiated with excitation light, and Raman scattering light from the sample is detected. A multivariate analysis of the Raman scattering light detected is carried out using scattering spectra which are specific to at least a living myocardial tissue, a necrotic myocardial tissue, a granulation tissue and a fibrotic tissue as an index, and the cardiac tissue is discriminated in accordance with the analysis results. Since the cardiac tissue is discriminated in accordance with scattering spectra specific to at least a living myocardial tissue, a necrotic myocardial tissue, a granulation tissue and a fibrotic tissue, accurate discrimination results can be constantly obtained irrespective of a time period passed after the occurrence of an ischemic heart disease such as myocardial infarction.

In the present invention, a partial least squares method is employed as a procedure for the multivariate analysis in analyzing the detected Raman scattering light. Therefore, owing to use of the discrimination information, high accuracy of estimation is attained, and influences from the noise can be lessened since a small number of principal components are used.

According to the present invention, a discrimination of a cardiac tissue is enabled noninvasively and in real time on the heart of any state, through accurately distinguishing an area of the living myocardial tissue, an area of the necrotic myocardial tissue, an area of the granulation tissue, and an area of the fibrotic tissue. Therefore, it becomes possible to accurately diagnose the heart suffering from ischemia such as myocardial infarction, and thus an appropriate care can be performed.

The above and further objects and features of the invention will more fully be apparent from the following detailed description with accompanying drawings.

### BRIEF DESCRIPTION OF THE DRAWINGS

FIG. 1 is a schematic view illustrating one example of a configuration of a discrimination apparatus of a cardiac tissue using Raman scattering according to the present invention;

FIG. 2 is a diagram illustrating Raman spectra which are specific to a living myocardial tissue, a necrotic myocardial tissue, a granulation tissue and a fibrotic tissue, respectively;

FIGS. 3A to 3D are diagrams illustrating one example of the first principal component to the fourth principal component in a partial least squares method;

FIGS. 4A and 4B are diagrams illustrating one example of results of plotting scores on the proportionality factor of each principal component in a partial least squares method;

FIGS. 5A to 5F are diagrams illustrating straight lines for discriminating a cardiac tissue; and

FIG. 6 is a table presenting accuracy on discrimination results of each cardiac tissue.

### DETAILED DESCRIPTION

Hereinafter, the present invention will be specifically explained with reference to drawings illustrating embodiments thereof.

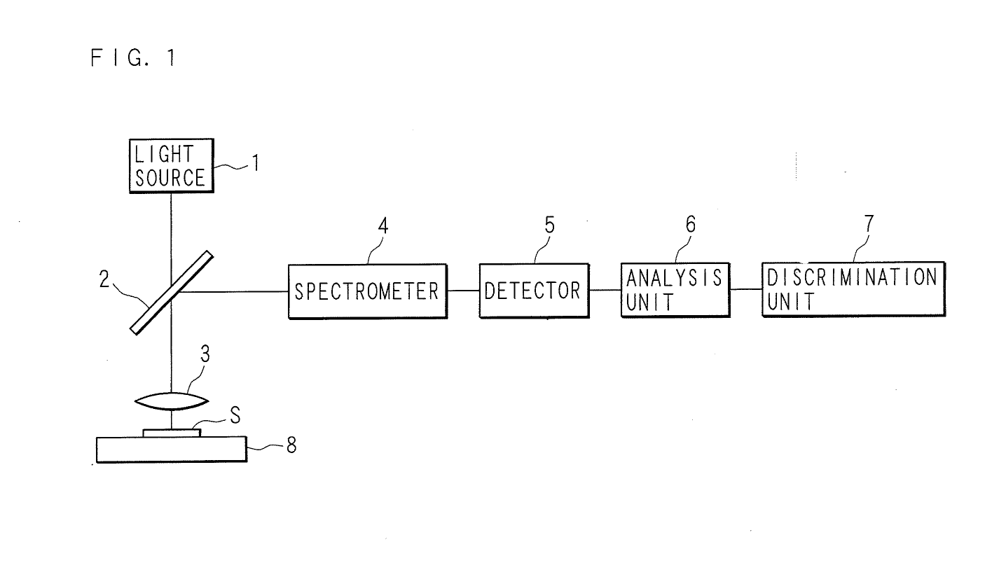

FIG. 1 is a schematic view illustrating one example of a configuration of the discrimination apparatus of a cardiac tissue using Raman scattering according to the present invention. The discrimination apparatus involves: irradiating a sample containing a cardiac tissue with excitation light; detecting Raman scattering light from the sample; analyzing the detected Raman scattering light by a multivariate analysis using as an index, Raman scattering spectra which are specific to at least a living myocardial tissue, a necrotic myocardial tissue, a granulation tissue and a fibrotic tissue, respectively; and discriminating the cardiac tissue in accordance with analysis results.

The discrimination apparatus is provided with a light source 1, a beam splitter 2, an objective lens 3, a spectrometer 4, a detector 5, an analysis unit 6, a discrimination unit 7, and a sample platform 8.

A sample S containing a cardiac tissue is mounted on the sample platform 8. The sample platform 8 is configured so as to be movable in two-dimensional directions (X-Y directions), and enable a Raman scattering spectrum to be detected by irradiating the sample S with excitation light at arbitrary points.

The light source 1 exits a laser beam that is to be excitation light. The excitation light is a laser beam that generates Raman scattering light peculiar to a substance constituting the sample S upon irradiating the sample S. As the excitation light, one light generally used in the technical field of Raman scattering method may be employed, and any arbitrary excitation light may be selected as long as a discrimination of a living myocardial tissue, a necrotic myocardial tissue, a granulation tissue and a fibrotic tissue is enabled, as described later. Specifically, for example, an Nd:YAG laser beam having a center wavelength of 532 nm may be used as the excitation light.

The excitation light exited from the light source 1 transmits through the beam splitter 2, and enters into the objective lens 3. The beam splitter 2 is, for example, a dichroic mirror, and transmits the light corresponding to the wavelength of the excitation light (laser beam). The objective lens 3 allows the excitation light to be condensed, and to enter into the sample S.

A part of the excitation light entered into the sample S is Raman scattered. The Raman scattering light has a spectrum specific to the material feature of the sample S, and has a wavelength that is different from the excitation light. In addition, a part of the excitation light entered into the sample S is reflected on the sample S to yield reflected light having an unchanged wavelength being the same as that of the excitation light. The Raman scattering light and the reflected light enter into the beam splitter 2 via the objective lens 3. The beam splitter 2 composed of the dichroic mirror separates these Raman scattering light and reflected light in accordance with the wavelengths. In other words, the Raman scattering light is reflected on the beam splitter 2 and enters into the spectrometer 4, whereas the reflected light transmits through the beam splitter 2 as is.

The spectrometer 4 is provided with a spectrum element such as a diffraction grating or a prism, and allows entered Raman scattering light to be spatially dispersed in accordance with the wavelength. The Raman scattering light dispersed by the spectrometer 4 enters into the detector 5. The detector 5 detects the Raman scattering light dispersed by the spectrometer 4 to obtain a Raman spectrum. The detector 5 is an area sensor in which photo-sensitive elements are arranged to give a matrix form. The detector 5 outputs the resultant Raman spectrum to the analysis unit 6.

The analysis unit 6 and the discrimination unit 7 are, for example, integrated into a personal computer. The analysis unit 6 performs a multivariate analysis on the Raman spectrum obtained from the detected Raman scattering light by a partial least squares method using as an index stored beforehand Raman spectra specific to a living myocardial tissue, a necrotic myocardial tissue, a granulation tissue and a fibrotic tissue. The analysis unit 6 outputs the analysis results to the discrimination unit 7, and the discrimination unit 7 discriminates the cardiac tissue contained in the sample S into a living myocardial tissue, a necrotic myocardial tissue, a granulation tissue and a fibrotic tissue, in accordance with the analysis results.

It is to be noted that the configuration of the discrimination apparatus shown in FIG. 1 is merely one example, and the present invention is not limited to such a configuration.

The Raman spectrum specific to the living myocardial tissue is a spectrum of Raman scattering light that is peculiar to a living myocardial tissue and that is obtained by irradiating the living myocardial tissue with excitation light. In a Raman spectrum specific to a living myocardial tissue when excited at 532 nm, for example, a peak pattern of Raman shift derived from cytochrome in myocardial cells can be found.

Whereas, the Raman spectrum specific to the necrotic myocardial tissue is a spectrum of Raman scattering light that is peculiar to a necrotic myocardial tissue and that is obtained by irradiating the necrotic myocardial tissue with excitation light, and the Raman spectrum specific to the granulation tissue is a spectrum of Raman scattering light that is peculiar to a granulation tissue and that is obtained by irradiating the granulation tissue with excitation light. Similarly, the Raman spectrum specific to the fibrotic tissue is a spectrum of Raman scattering light that is peculiar to a fibrotic tissue and that is obtained by irradiating the fibrotic tissue with excitation light. In a Raman spectrum specific to a fibrotic tissue when excited at 532 nm, for example, a peak pattern of Raman shift derived from collagen, an interstitial fluid and the like in the fibrotic tissue can be found.

The discrimination of a tissue by an analysis using a Raman spectrum specific to a living myocardial tissue as referred to herein means, depending on as to whether or not Raman scattering light showing a Raman spectrum that matches a spectrum specific to a living myocardial tissue has been detected, deciding as to the site in the sample S yielding the Raman scattering light does or does not correspond to a living myocardial tissue. Also, depending on as to whether or not Raman scattering light showing a Raman spectrum that matches a spectrum specific to a necrotic myocardial tissue has been detected, a decision is made as to the site in the sample S yielding the Raman scattering light does or does not correspond to a necrotic myocardial tissue, whereas depending on as to whether or not Raman scattering light showing a Raman spectrum that matches a spectrum specific to a granulation tissue has been detected, a decision is made as to the site in the sample S yielding the Raman scattered light does or does not correspond to a granulation tissue. Similarly, the presence or absence of a fibrotic tissue at a particular site in the sample S is decided depending on as to whether or not Raman scattering light from the sample S shows a Raman spectrum specific to a fibrotic tissue.

The analysis of distribution of the Raman spectrum obtained from the sample S is carried out using a partial least squares method.

The partial least squares method is one of multivariate analysis methods, and calculates latent variables, which are highly related to objective variables, from a plurality of observation variables, and produces a predictive model for explaining objective variables using the calculated latent variables as explanatory variables. In this method, the latent variables may be determined such that covariance of the objective variables and the latent variables can be maximized, whereby a model that explains the objective variables with superior accuracy can be produced using a fewer latent variables.

More specifically, in the Raman spectrum analysis of a tissue according to the present invention, types of tissues (living myocardial tissue, necrotic myocardial tissue, granulation tissue and fibrotic tissue) are adopted as objective variables, and Raman spectra specific to respective tissues are adopted as observation variables, respectively, and thus a model for estimation of the tissue can be produced from the observed Raman spectra.

Alternatively, by adopting Raman spectra obtained when a plurality of tissues are admixed, as objective variables and observation variables, it is also possible to produce a model that predicts the composition of each tissue constituting the mixture, from the obtained Raman spectra.

The calculation principle of the partial least squares method involve: (1) adopting the types of the tissue as objective variables, and adopting the Raman spectra of the tissues corresponding to the types of the tissue as observation variables; (2) centering all variables; (3) representing the explanatory variables in terms of the product of the latent variables and the factor loading, and calculating, from the observation variables, the latent variables and the factor loading that maximize covariance of the objective variables and the latent variables; (4) defining the resultant explanatory variables as a first principal component; (5) similarly defining new observation variables as a second principal component by excluding the first principal component from the observation variables; (6) further obtaining a third principal component, a fourth principal component . . . to a “n”th principal component; and (7) producing a predictive model using the resultant first principal component to the “n”th principal component.

In addition to the partial least squares method, the multivariate analysis method for analyzing the Raman spectrum includes: a least squares analysis method in which a linear combination of a plurality of observation variables (Raman spectra) is determined by a least squares method; a principal component analysis method in which a principal component that summarizes a plurality of observation variables (Raman spectra) is generated therefrom; and the like.

The former least squares analysis method is based on a premise of a linear combination of a plurality of Raman spectra, and a simple linear addition of four types of Raman spectra specific to four types of tissues, respectively, is determined by a least squares method. Therefore, this method is a intuitive procedure aiming at a clear purpose of discriminating a tissue. However, due to the indication in terms of simple addition results, when Raman spectra specific to four types of tissues are similar, it is possible that, for example, the spectrum which should be derived from a living myocardial tissue is erroneously indicated as an addition of a spectrum derived from a necrotic myocardial tissue and a spectrum derived from a granulation tissue. Accordingly, there exist problems such as aptness of occurrence of the noise, and inferior accuracy of estimation of the tissue.

In the latter principal component analysis method, an average of the entire spectra obtained is extracted to define the first principal component, and a spectrum orthogonal to the first principal component is found to define the second principal component. Then such a process is repeated to define, the third principal component, . . . , and the “n”th principal component. Since each spectrum is orthogonal to one another, a coefficient of each principal component (proportionality factor) does not affect with one another; therefore, accuracy of estimation of the tissue is superior to that of the least squares analysis method. However, since linear addition results are obtained using an average of the entire spectra as the first principal component without intending a discrimination into each tissue, a large number of (20 components or more) of principal components are essential in order to correctly discriminate the tissue. Therefore, since a large number of principal components are used, the number of times of division of the spectra increases, whereby a problem of aptness of influences from the noise is involved.

Contrary to these methods, in a partial least squares method, although the spectra are divided based on the orthogonal relation similarly to the principal component analysis method, a spectrum with great covariance is employed as the first principal component that enables division into four types of tissues to meet the purpose of carrying out the discrimination of each tissue, and the second principal component is calculated such that latent variables calculated from the first principal component are orthogonal thereto. Thus, the third principal component, . . . , and the “n”th principal component being orthogonal to each other are sequentially determined. Owing to the use of the discrimination information, high accuracy of estimation of the tissue is attained. In addition, since the employed first principal component is easily dividable, the discrimination of the tissue can be conducted with a small number of principal components. Therefore, influences from the noise can be lessened since only a small number of principal components (about four components) are used. Furthermore, by appropriately selecting a weight coefficient, a quantitative determination analysis of each tissue for determining the composition of each tissue is also enabled.

The discrimination analysis for discriminating a tissue is carried out as in the following. Using the predictive model produced by the partial least squares method as described above, a discrimination of a tissue a Raman spectrum of which has been newly observed is conducted. In this process, the discrimination analysis leads to a discrimination as to which tissue the subject belongs to. For example, a linear discriminator, a discriminator in which a Mahalanobis' generalized distance is used or the like may be used. The linear discriminator, discriminator or the like is provided in the analysis unit 6 shown in FIG. 1. The linear discriminator is explained below. The linear discriminator calculates a point, a straight line, or a hyperplane which can most appropriately discriminate each group based on the results obtained from the predictive model. With respect to a calculation principle of the linear discriminator, a point, a straight line, or a hyperplane where an incorrect discrimination can be minimized is searched from the input data (for example, a predictive model obtained by a partial least squares method).

### EXAMPLES

### Test Example

### Preparation of a Model of Heart Having Myocardial Infarction

The specimens used in Examples described later were produced as follows. Specimens of the entirety of the heart were removed from young adult Wistar rats (body weight: 160-180 g; female) under general anesthesia with feeding 100% oxygen. The extirpated heart was perfused with a Tyrode solution, and left to stand to minimize metabolic degradation after the extirpation.

Myocardial infarction was caused by ligature of the left coronary artery of the rat or branches of the left coronary artery completely. On day 2 (n=4), day 5 (n=5), and day 21 (n=5) after the ligature, the heart was carefully extirpated from surviving rats. Immediately thereafter, normal heart (n=5) and the heart having myocardial infarction were embedded into an OCT compound, frozen with dry ice-acetone, and stored at −80° C. until use for verification.

### (Discrimination of the Tissue by Stained Image)

The frozen sample was sliced to give a section having a thickness of 20 μm using a cryostat (LEICA, Wetzler, Germany). The sample for a Raman analysis was mounted on a quartz glass having a thickness of 0.17 mm (Matsunami, Osaka, Japan). The tissue of the section was ascertained using hematoxylin-eosin stain and azan stain.

As a result, a living myocardial tissue was confirmed from the normal heart, whereas with respect to the heart of rats on day 2, day 5, and day 21 after the ligature of the artery, a necrotic myocardial tissue, a granulation tissue and a fibrotic tissue could be confirmed, respectively, as stained histopathological images.

### (Acquisition of Raman Spectrum)

For acquiring Raman spectra, a confocal laser Raman microscope (RAMAN-11: Nanophoton, Osaka) was used. For the excitation light, an Nd:YAG laser beam having a center wavelength of 532 nm was used, with the intensity of the excitation light being 0.021-0.13 mW/μm², and the Raman spectrum was measured with an exposure time of 10 sec. From the heart of the normal rats, a Raman spectrum specific to a living myocardial tissue was acquired. Whereas, from the heart of rats on day 2, day 5, and day 21 after the ligature of the artery, Raman spectra specific to a necrotic myocardial tissue, a granulation tissue and a fibrotic tissue were acquired, respectively. In this experiment, 9-24 Raman spectra were acquired from the heart of each rat.

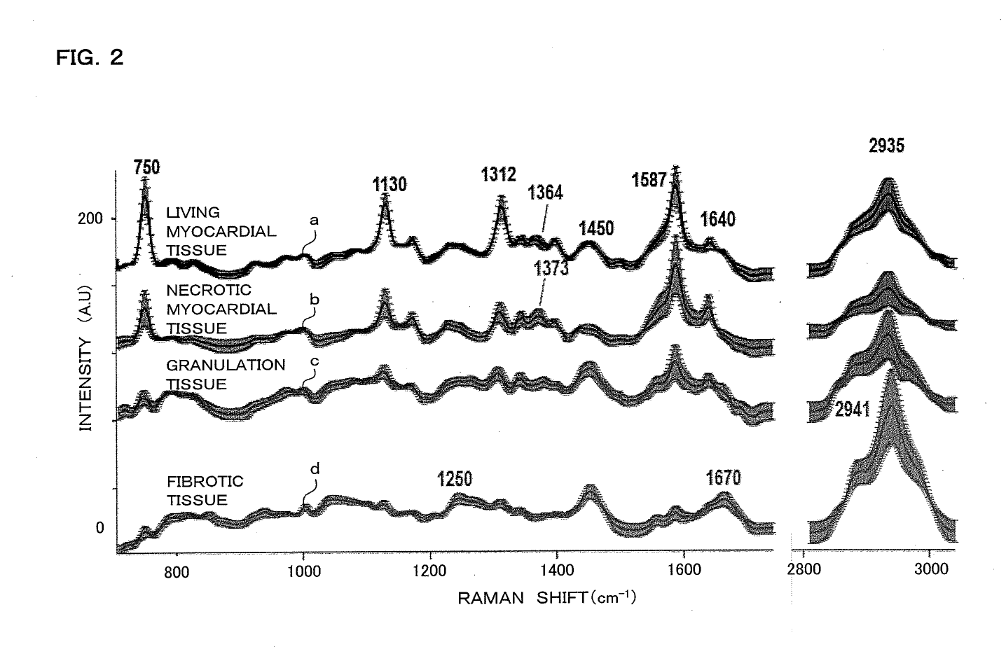

FIG. 2 shows acquired Raman spectra which are specific to a living myocardial tissue, a necrotic myocardial tissue, a granulation tissue and a fibrotic tissue, respectively. The abscissa in FIG. 2 represents Raman shift (cm⁻¹), whereas the ordinate represents the intensity (A.U.: arbitrary unit). In FIG. 2, a, b, c and d present specific Raman spectra derived from a living myocardial tissue, a necrotic myocardial tissue, a granulation tissue and a fibrotic tissue, respectively.

The Raman spectra of the living myocardial tissue, the necrotic myocardial tissue, the granulation tissue and the fibrotic tissue, respectively, include some specific Raman bands (peaks). For example, Raman bands specific in the Raman spectrum of the living myocardial tissue are considered to be certain vibration modes generated from a porphyrin ring present in the center of a heme protein, showing specific Raman bands at 750, 1,130, 1,312, 1,364, 1,450, 1,587, 1,640, 2,935 cm⁻¹ and the like, and the spectrum peaks specific to the living myocardial tissue well correspond to the spectrum peaks specific to reduced cytochrome. Further, Raman bands specific in the Raman spectrum of the necrotic myocardial tissue are considered to be derived from myocardial cells having necrosis, showing specific Raman bands at 750, 1,130, 1,312, 1,373, 1,587, 1,640, 2,935 cm⁻¹ and the like. Moreover, Raman bands specific in the Raman spectrum of the granulation tissue are considered to be derived from inflammatory cells, blood vessels, blood and the like, showing specific Raman bands at 750, 1,130, 1,312, 1,373, 1,587, 1,640, 2,935 cm⁻¹ and the like. Furthermore, Raman bands specific in the Raman spectrum of the fibrotic tissue are considered to be certain vibration modes generated from collagen molecules, showing specific Raman bands at 1,250, 1,670, 2,941 cm⁻¹ and the like, and the spectrum peaks specific to the fibrotic tissue which well correspond to the spectrum peaks specific to collagen type I.

### (Analysis and Discrimination Processing (Data Processing))

Using the acquired Raman spectra, a predictive model was produced and a discrimination of the tissue was conducted by a partial least squares method discriminator. As the partial least squares method discriminator, a PLS_toolbox (Eigenvector Research, Wenatchee, Wash.) and MATLAB (Mathworks Inc., Natick, Mass.) were used. Further, for the partial least squares method discriminator, Raman shift regions of 706 to 765 cm⁻¹ and 1,091 to 1,700 cm⁻¹ in the acquired Raman spectra were employed.

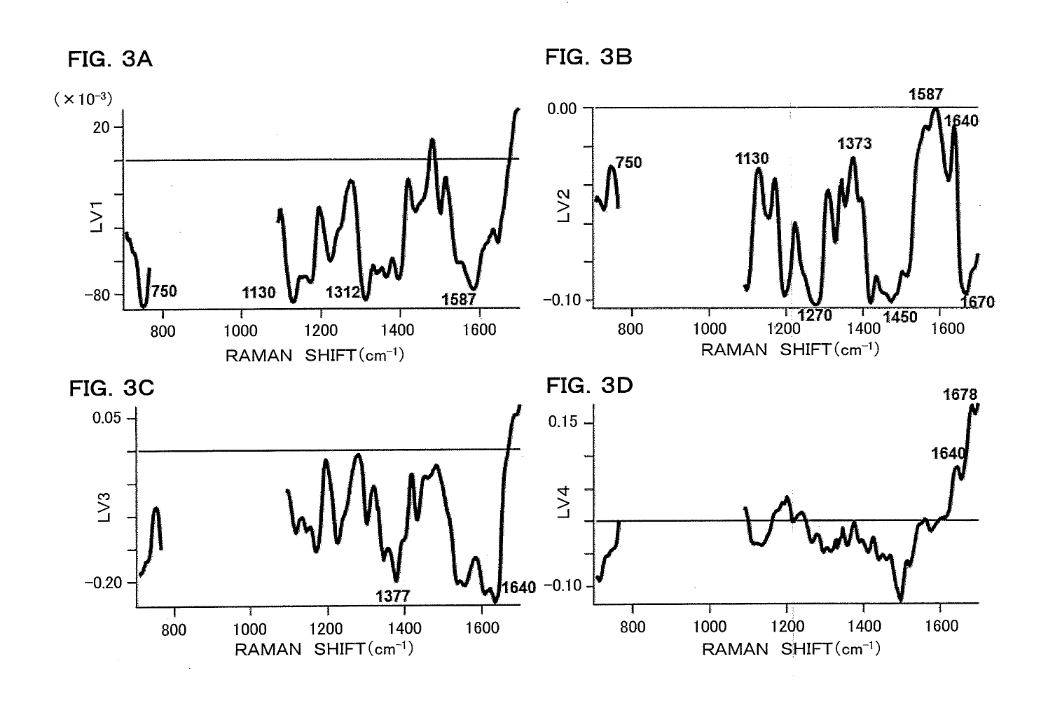

FIGS. 3A to 3D are diagrams illustrating one example of the first principal component to the fourth principal component in a partial least squares method. FIG. 3A indicates the first principal component (LV1), FIG. 3B indicates the second principal component (LV2); FIG. 3C indicates the third principal component (LV3); and FIG. 3D indicates the fourth principal component (LV4). According to the first principal component (LV1) indicated in FIG. 3A that exhibits the difference of four types of tissues as much as possible, bands (750 cm⁻¹, 1,130 cm⁻¹, 1,312 cm⁻¹) approximate to cytochrome, for example, were obtained, and it is proved that a discrimination of four types of tissues can be easily conducted when these bands are regarded as the first principal component.

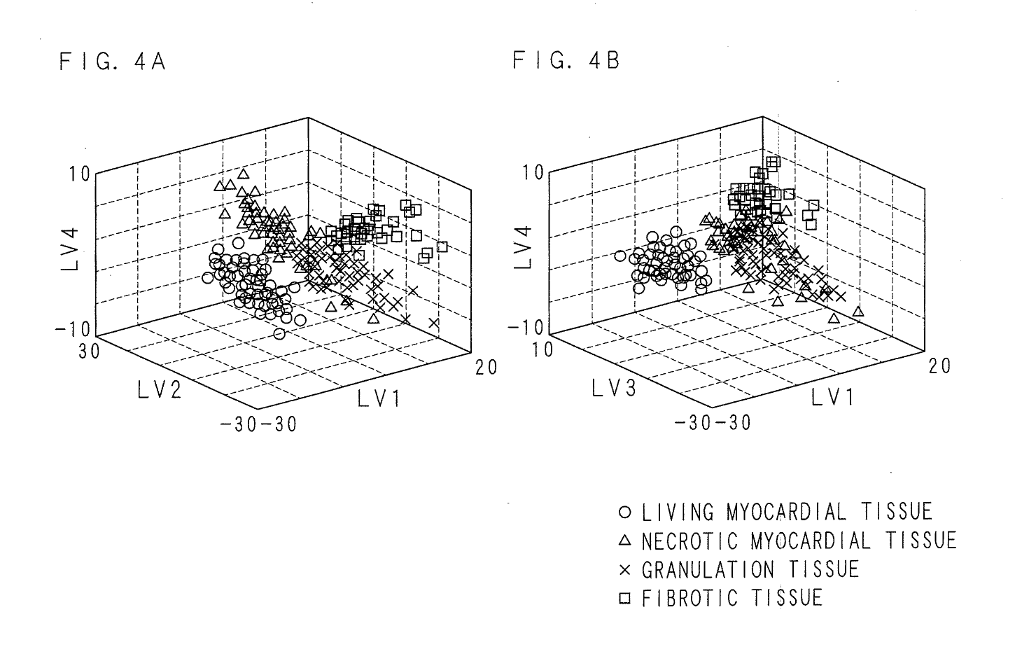

FIGS. 4A and 4B are diagrams illustrating one example of results of plotting scores on the proportionality factor of each principal component in a partial least squares method. In FIG. 4A, LV1, LV2 and LV4 are presented on orthogonal triaxes, the score plots of the proportionality factors of the first principal component, the second principal component and the fourth principal component are shown. Whereas in FIG. 4B, LV1, LV3 and LV4 are presented on orthogonal triaxes, the score plots of the proportionality factors of the first principal component, the third principal component and the fourth principal component are shown.

Both of FIGS. 4A and 4B suggest that living myocardial tissues (∘), necrotic myocardial tissues (Δ), granulation tissues (x) and fibrotic tissues (□) are clustered. Therefore, it is comprehended that by cutting off the principal component scores at any point, a discrimination of the subject tissue of heart to any one of a living myocardial tissue, a necrotic myocardial tissue, a granulation tissue and a fibrotic tissue is enabled.

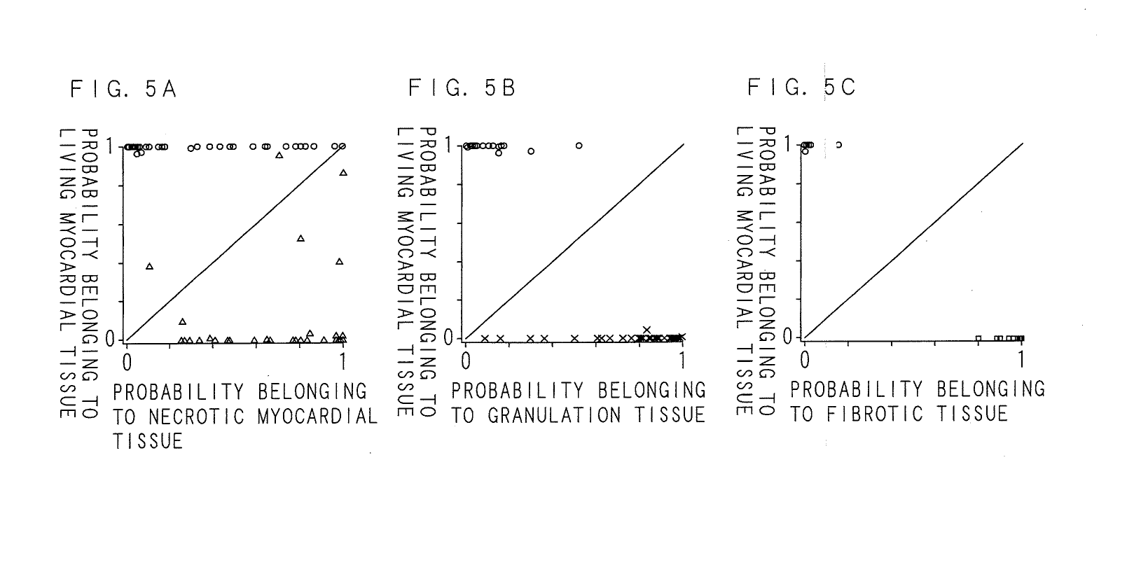

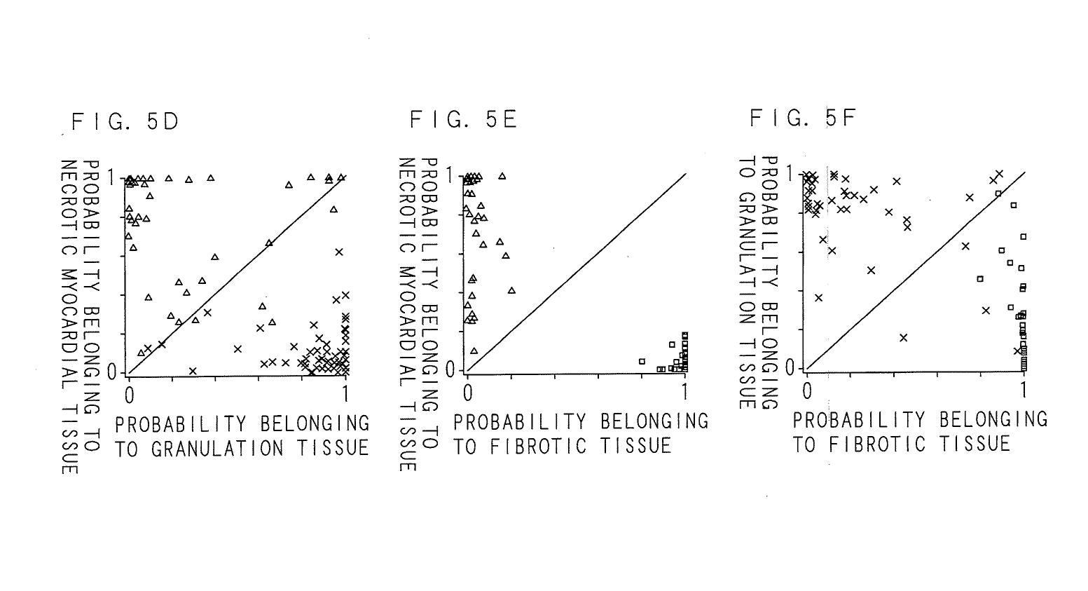

In addition, FIGS. 5A to 5F are diagrams illustrating straight lines for discriminating a cardiac tissue. The abscissa in FIG. 5A represents probability belonging to the necrotic myocardial tissue, whereas the ordinate represents probability belonging to the living myocardial tissue, thereby indicating a straight line that discriminates the living myocardial tissue (∘) and the necrotic myocardial tissue (Δ). Similarly, the abscissa in FIG. 5B represents probability belonging to the granulation tissue, whereas the ordinate represents probability belonging to the living myocardial tissue, thereby indicating a straight line that discriminates the living myocardial tissue (∘) and the granulation tissue (x). The abscissa in FIG. 5C represents probability belonging to the fibrotic tissue, whereas the ordinate represents probability belonging to the living myocardial tissue, thereby indicating a straight line that discriminates the living myocardial tissue (∘) and the fibrotic tissue (□). The abscissa in FIG. 5D represents probability belonging to the granulation tissue, whereas the ordinate represents probability belonging to the necrotic myocardial tissue, thereby indicating a straight line that discriminates the necrotic myocardial tissue (Δ) and the granulation tissue (x). The abscissa in FIG. 5E represents probability belonging to the fibrotic tissue, whereas the ordinate represents probability belonging to the necrotic myocardial tissue, thereby indicating a straight line that discriminates the necrotic myocardial tissue (Δ) and the fibrotic tissue (□). The abscissa in FIG. 5F represents probability belonging to the fibrotic tissue, whereas the ordinate represents probability belonging to the granulation tissue, thereby indicating a straight line that discriminates the granulation tissue (x) and the fibrotic tissue (□).

The certain straight lines as shown in FIGS. 5A to 5F are obtained by a linear discriminator. From the results shown in FIGS. 5A to 5F, it is comprehended that by specifying straight lines that are optimal for discriminating different tissues, a living myocardial tissue, a necrotic myocardial tissue, a granulation tissue and a fibrotic tissue can be accurately discriminated to one another. Therefore, a discrimination of the tissue of the heart can be conducted with high accuracy according to the present invention.

### (Accuracy of Discrimination Results)

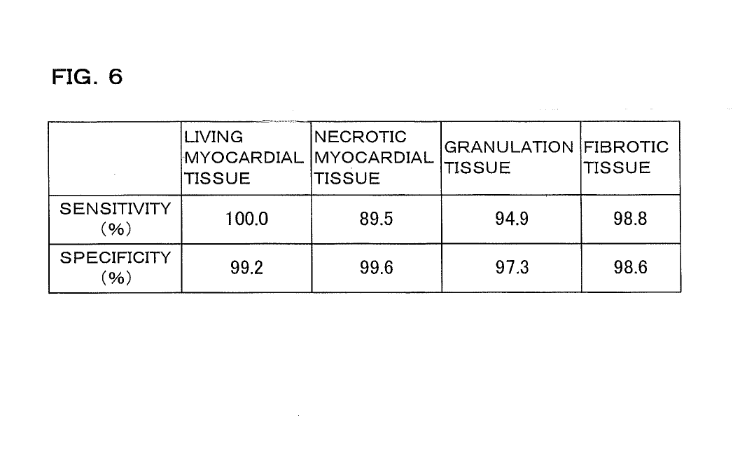

FIG. 6 is a table presenting accuracy on discrimination results. FIG. 6 shows values of the discrimination results, i.e., the sensitivity (%) and the specificity (%), in the living myocardial tissue, the necrotic myocardial tissue, the granulation tissue and the fibrotic tissue, respectively, discriminated according to the present invention. The sensitivity (%) is a value suggesting as to how many real and correct tissues could be certainly discriminated, and the specificity (%) is a value suggesting as to how many wrong tissues could be obviated.

From the results shown in FIG. 6, great values for both the sensitivity and the specificity are obtained in all tissues. Therefore, it is proved that an accurate discrimination of the living myocardial tissue, the necrotic myocardial tissue, the granulation tissue and the fibrotic tissue was enabled with respect to the heart having myocardial infarction.

It is to be noted that although an embodiment has been explained by way of an example with reference to heart of the rat suffering from myocardial infarction, it is also possible to similarly apply the method of the present invention to heart of other organisms such as human, as a matter of course.

Further, in the embodiment described above, a case in which a cardiac tissue is discriminated using as an index, Raman spectra specific to four types of tissues of a living myocardial tissue, a necrotic myocardial tissue, a granulation tissue and a fibrotic tissue has been explained; however, it is acceptable as long as Raman spectra specific to at least these four types of tissues are involved. In addition to the Raman spectra specific to these four types of tissues, Raman spectra specific to other type of tissues such as a tissue containing fats and a tissue containing β-carotene may be used as an index for discriminating a cardiac tissue, as a matter of course.

Furthermore, a case in which a partial least squares method is used when a multivariate analysis is carried out has been explained in the embodiment described above; however, other multivariate analysis method such as a least squares analysis method or a principal component analysis method may be also used.

Moreover, a case in which excitation light having a center wavelength of 532 nm is used has been explained in the embodiment described above; however, excitation light having a center wavelength of 633 nm, 785 nm or the like that generates a spectrum other than the spectrum of cytochrome relatively intensely may be also employed.

As this invention may be embodied in several forms without departing from the spirit of essential characteristics thereof, the present embodiment is therefore illustrative and not restrictive, since the scope of the invention is defined by the appended claims rather than by the description preceding them, and all changes that fall within metes and bounds of the claims, or equivalence of such metes and bounds thereof are therefore intended to be embraced by the claims.

What is claimed is:

1. A discrimination method of a cardiac tissue using Raman scattering, comprising:
a step of irradiating a sample containing a cardiac tissue with excitation light;
a step of detecting Raman scattering light from the sample;
an analysis step of analyzing the detected Raman scattering light by a multivariate analysis using as an index, Raman scattering spectra which are specific to at least a living myocardial tissue, a necrotic myocardial tissue, a granulation tissue and a fibrotic tissue, respectively; and
a step of discriminating the cardiac tissue in accordance with analysis results obtained in the analysis step.

2. The discrimination method of a cardiac tissue according to claim 1, wherein
a partial least squares method is employed for the multivariate analysis in the analysis step.

3. The discrimination method of a cardiac tissue according to claim 1, wherein
the Raman scattering spectrum specific to the living myocardial tissue is a Raman scattering spectrum derived from cytochrome.

4. The discrimination method of a cardiac tissue according to claim 1, wherein
the Raman scattering spectrum specific to the fibrotic tissue is a Raman scattering spectrum derived from collagen.

5. The discrimination method of a cardiac tissue according to claim 1, wherein
the sample contains an ischemic cardiac tissue.

6. A discrimination apparatus of a cardiac tissue using Raman scattering, comprising:
an irradiation unit configured to irradiate a sample containing a cardiac tissue with excitation light;
a detection unit configured to detect Raman scattering light from the sample;
an analysis unit configured to analyze the detected Raman scattering light by a multivariate analysis using as an index, Raman scattering spectra which are specific to at least a living myocardial tissue, a necrotic myocardial tissue, a granulation tissue and a fibrotic tissue, respectively; and
a discrimination unit configured to discriminate the cardiac tissue in accordance with analysis results obtained by the analysis unit.

7. The discrimination apparatus of a cardiac tissue according to claim 6, wherein
a partial least squares method is employed for the multivariate analysis by the analysis unit.

8. The discrimination apparatus of a cardiac tissue according to claim 6, wherein
the Raman scattering spectrum specific to the living myocardial tissue is a Raman scattering spectrum derived from cytochrome.

9. The discrimination apparatus of a cardiac tissue according to claim 6, wherein
the Raman scattering spectrum specific to the fibrotic tissue is a Raman scattering spectrum derived from collagen.

10. The discrimination apparatus of a cardiac tissue according to claim 6, wherein
the sample contains an ischemic cardiac tissue.
